(19) United States
(12) Patent Application Publication
(10) Pub. No.: US 2025/0362858 A1
(43) Pub. Date: Nov. 27, 2025

(54) ELECTRONIC APPARATUS AND DATA DISPLAY METHOD THEREOF

(71) Applicant: COMPAL ELECTRONICS, INC., Taipei City (TW)

(72) Inventors: Yi-Chia Lee, Taipei City (TW); Yu-Wen Cheng, Taipei City (TW); You-Ning Huang, Taipei City (TW); Kuan-Chen Lu, Taipei City (TW); Yun-Liang Hsu, Taipei City (TW)

(73) Assignee: COMPAL ELECTRONICS, INC., Taipei City (TW)

(21) Appl. No.: 19/204,586

(22) Filed: May 11, 2025

Related U.S. Application Data
(60) Provisional application No. 63/650,914, filed on May 23, 2024.

(51) Int. Cl. G06F 3/14; G06F 40/205; G06T 11/60

(52) U.S. Cl. CPC G06F 3/1446; G06F 40/205; G06T 11/60

(57) ABSTRACT

An electronic apparatus and a data display method thereof are provided. The electronic apparatus includes a first display and a second display. The data display method includes: in response to detecting that the first display and the second display are substantially facing the same side, enabling an operation judgment module; and in response to judging that a designated operation for the first display is received through the operation judgment module, including: obtaining a content to be processed from a display screen of the first display based on the designated operation; generating a result via analyzing the content to be processed; and displaying the result on the second display.

### CROSS-REFERENCE TO RELATED APPLICATION

This application claims the priority benefit of U.S. provisional application Ser. No. 63/650,914, filed on May 23, 2024. The entirety of the above-mentioned patent application is hereby incorporated by reference herein and made a part of this specification

### BACKGROUND

### Technical Field

The disclosure relates to an interface interaction method and an electronic apparatus, and more particularly to an electronic apparatus having multiple displays and a data display method thereof.

### Description of Related Art

Since a traditional notebook computer has a single display, a user may experience low efficiency when multitasking. With the advancement of technology, notebook computers having dual displays are gradually being launched on the market, so as to provide users with more convenient usage experience. The notebook computers having dual displays can significantly improve efficiency of multitask processing. For example, the user works on the main display, such as writing documents and processing data, and performs real-time querying, monitoring, or displaying of other information on the second display. In addition, the artificial intelligence generated content has become a trend, but currently only interactive operations on a single display are considered. Therefore, how to determine the combined usage of the main display and the secondary display to improve the working efficiency of the artificial intelligence generated content is one of the issues that need to be improved currently.

### SUMMARY

The disclosure provides an electronic apparatus and a data display method thereof, which provide an interface interaction method for the electronic apparatus having at least two displays.

In a data display method of an electronic apparatus of the disclosure, the electronic apparatus includes a first display and a second display. The data display method includes executing following steps via a processor. In response to detecting that the first display and the second display are substantially facing a same side, an operation judgement module is enabled. In response to receiving a designated operation for the first display through the operation judgement module, a content to be processed is obtained from a display screen of the first display based on the designated operation; a result is generated via analyzing the content to be processed; and the result is displayed on the second display.

An electronic apparatus of the disclosure includes a first display; a second display; and a processor, coupled to the first display and the second display, and configured to execute the following operations. In response to detecting that the first display and the second display are substantially facing a same side, an operation judgement module is enabled. In response to receiving a designated operation for the first display through the operation judgement module, a content to be processed is obtained from a display screen of the first display based on the designated operation; a result is generated via analyzing the content to be processed; and the result is displayed on the second display.

Based on the above, in the disclosure, the result to be presented on the second display is generated via sensing the position of the second display relative to the first display, and further confirming the designated operation (for example, a screenshot operation or a text selection operation) for the first display by the user for analysis. Accordingly, the result of the operation is presented through the second display without affecting the display screen of the first display, thereby improving the working efficiency of the electronic apparatus.

### BRIEF DESCRIPTION OF THE DRAWINGS

FIG. 1 is a block diagram of an electronic apparatus according to an embodiment of the disclosure.

FIG. 2A to FIG. 2D are schematic diagrams of an electronic apparatus according to an embodiment of the disclosure.

FIG. 3 is a flowchart of a data display method of an electronic apparatus according to an embodiment of the disclosure.

FIG. 4 is a schematic diagram of a screenshot operation according to an embodiment of the disclosure.

FIG. 5 is a schematic diagram of a text selection operation according to an embodiment of the disclosure.

FIG. 6A to FIG. 6C are schematic diagrams of a generation result displayed on a second display based on different task command descriptions according to an embodiment of the disclosure.

FIG. 7 is a schematic diagram of a generated content based on environmental information according to an embodiment of the disclosure.

FIG. 8 is a flowchart of a data display method of an electronic apparatus according to an embodiment of the disclosure.

FIG. 9 is a flowchart of generating a result via analyzing a content to be processed according to an embodiment of the disclosure.

FIG. 10 is a schematic diagram of data display in a multi-window situation according to an embodiment of the disclosure.

FIG. 11A and FIG. 11B are schematic diagrams of an application example of a second display according to an embodiment of the disclosure.

FIG. 12A and FIG. 12B are schematic diagrams of an electronic apparatus according to an embodiment of the disclosure.

### DESCRIPTION OF THE EMBODIMENTS

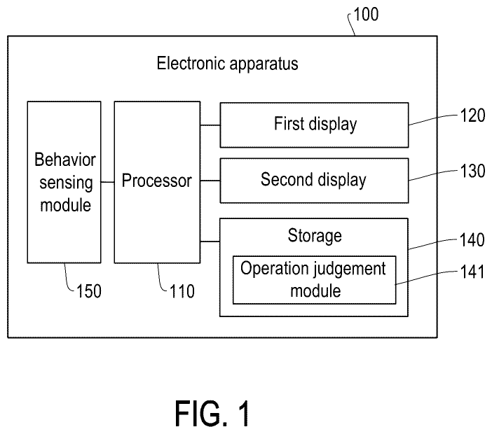

FIG. 1 is a block diagram of an electronic apparatus according to an embodiment of the disclosure. Please refer to FIG. 1. An electronic apparatus 100 includes a processor 110, a first display 120 (main display), a second display 130 (secondary display), a storage 140, and a behavior sensing module 150. The processor 110 is coupled to the first display 120, the second display 130, the storage 140, and the behavior sensing module 150.

The processor 110 may be, for example, a central processing unit (CPU), a physical processing unit (PPU), a programmable microprocessor, an embedded control chip, a digital signal processor (DSP), an application specific integrated circuit (ASIC), or other similar apparatuses. The processor 110 may also be implemented by any combination of the above components.

The first display 120 and the second display 130 are, for example, liquid crystal displays (LCD), light emitting diode (LED) displays, plasma displays, touch screens, other similar apparatuses, or combinations of the apparatuses.

The storage 140 may be implemented by any type of fixed or removable random-access memory (RAM), read-only memory (ROM), flash memory, hard disk, other similar apparatuses, or combinations of the apparatuses. The storage 140 may be independent and connected to the processor 110 by a communication bus, or the storage 140 and the processor 110 may be integrated together. In an embodiment, the storage 140 stores an operation judgement module 141 implemented by a program code segment. The processor 110 executes the operation judgement module 141 to confirm an operation behavior of a user on the first display 120, thereby determining a display content of the second display 130.

The behavior sensing module 150 includes at least one sensor such as a motion sensor for detecting an X, Y, or Z axis (or a combination thereof) and an angle sensor for measuring an angular change of an object. The relative positions of both the first display 120 and the second display 130 are detected through the behavior sensing module 150. In response to the behavior sensing module 150 detecting that the first display 120 and the second display 130 are substantially facing the same side, the operation judgement module 141 is enabled. The first display 120 and the second display 130 substantially facing the same side means that both the first display 120 and the second display 130 are located at positions for simultaneous viewing by the user. The first display 120 and the second display 130 do not need to be in parallel, as long as the user can simultaneously view display screens of both the first display 120 and the second display 130.

The operation judgement module 141 is used to detect a designated operation on the first display 120, a result corresponding to the operation is generated in combination with an artificial intelligence model, and the result is displayed on the second display 130. Accordingly, the electronic apparatus 100 of the disclosure provides an interface interaction method for the first display 120 and the second display 130, thereby determining the display screens of the first display 120 and the second display 130. In the disclosure, the position of the second display 130 is sensed by the behavior sensing module 150, and the designated operation on the first display 120 by the user is further confirmed. The artificial intelligence model is used to perform pre-processing, analysis, and generate a corresponding result, and the result is displayed on the second display 130.

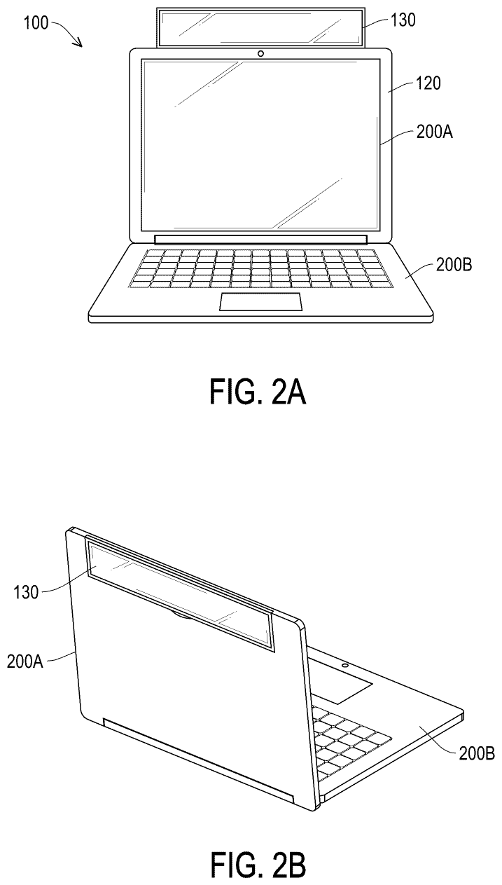

FIG. 2A to FIG. 2D are schematic diagrams of an electronic apparatus according to an embodiment of the disclosure. Please refer to FIG. 2A to FIG. 2D. The electronic apparatus 100 includes a first main body 200A and a second main body 200B. The first main body 200A is, for example, an upper cover, and the second main body 200B is, for example, a base with a keyboard. The first main body 200A includes the first display 120 and the second display 130. The second display 130 is disposed at a position different from that of the first display 120. The first main body 200A and the second main body 200B are connected through a pivot structure, and the first main body 200A and the second main body 200B are in a closed state or an unfolded state via the rotation of the pivot structure. FIG. 2A and FIG. 2B are schematic diagrams of the first main body 200A and the second main body 200B in the unfolded state, and FIG. 2C and FIG. 2D are schematic diagrams of the first main body 200A and the second main body 200B in the closed state, but only as examples and not limited thereto.

In the embodiment, the first display 120 is disposed on a side of the first main body 200A opposite to the keyboard disposed on the second main body 200B, and the first display 120 and the second display 130 are connected by an actuating module (for example, a hinge module). The second display 130 may be rotated (or moved or pulled) through the actuating module, so that an included angle between the second display 130 and the first main body 200A may be rotated between 0 and 180 degrees. That is, in the situation where the included angle between the second display 130 and the first main body 200A is 0 degrees, it means that the second display 130 is attached to a back surface side of the first main body 200A (a side opposite to where the first display 120 is disposed). In the situation where the included angle between the second display 130 and the first main body 200A is close to or equal to a designated angle, that is, the user can simultaneously view the first display 120 and the second display 130, it means that the second display 130 and the first display 120 are substantially facing the same side. For example, the designated angle may be set to 180 degrees or the designated angle may be any angle greater than 0 degrees and less than 180 degrees (for example, 45 degrees, 90 degrees, etc.).

As shown in FIG. 2A, the first main body 200A and the second main body 200B are in the unfolded state, and the second display 130 is rotated to a state of substantially facing the same side as the first display 120. In this state, the user can simultaneously view the first display 120 and the second display 130. As shown in FIG. 2B, the first main body 200A and the second main body 200B are in the unfolded state, and the second display 130 is attached to the back surface side of the first main body 200A (the included angle between the second display 130 and the first main body 200A is 0 degrees). Both the display screen of the second display 130 and the display screen of the first display 120 face opposite directions.

As shown in FIG. 2C, the first main body 200A and the second main body 200B are in the closed state, and the second display 130 is attached to the back surface side of the first main body 200A (the included angle between the second display 130 and the first main body 200A is 0 degrees). As shown in FIG. 2D, the first main body 200A and the second main body 200B are in the closed state, and the included angle between the second display 130 and the first main body 200A is, for example, 45 degrees, so that the second display 130 is erected from the first main body 200A.

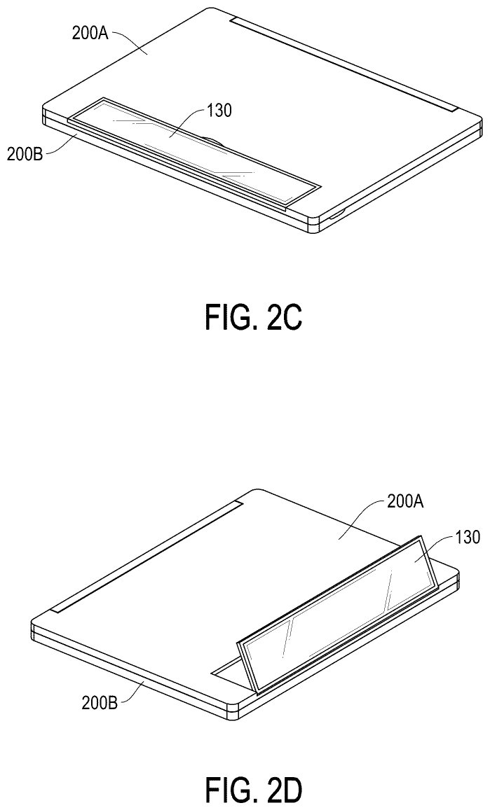

FIG. 3 is a flowchart of a data display method of an electronic apparatus according to an embodiment of the disclosure. The data display method of the embodiment is when the first main body 200A and the second main body 200B are in the unfolded state. Please refer to FIG. 3. In step S305, in response to detecting that the first display 120 and the second display 130 are substantially facing the same side (as shown in FIG. 2A), the operation judgement module 141 is enabled. For example, the position of the second display 130 is sensed through the behavior sensing module 150. In an embodiment, the position of the second display 130 may be judged by detecting the rotation angle of the second display 130 via the behavior sensing module 150. In addition, a viewing direction in which both the screens of the second display 130 and the first display 120 are not facing the same side is regarded as a first position, and the operation judgement module 141 is disabled at this time. In addition, a viewing direction in which both the screens of the second display 130 and the first display 120 are substantially facing the same side is regarded as a second position, and the operation judgement module 141 is enabled at this time.

After judging that the first display 120 and the second display 130 are substantially facing the same side, the operation judgement module 141 is enabled. In step S310, the processor 110 judges whether the designated operation for the first display 120 is received through the operation judgement module 141. In an embodiment, the designated operation is a screenshot operation or a text selection operation.

In response to judging that the designated operation for the first display 120 is received through the operation judgement module 141, the processor 110 executes steps S315 to S325. In step S315, a content to be processed is obtained from the display screen of the first display 120 based on the designated operation through the operation judgement module 141. In step S320, a result is generated via analyzing the content to be processed through the operation judgement module 141. During the process of analyzing the content to be processed through the operation judgement module 141, a waiting screen may be displayed on the second display 130. Afterwards, after the result is generated, in step S325, the result is displayed on the second display 130 through the operation judgement module 141. The result is, for example, an artificial intelligence generated content (AIGC).

In an embodiment, the operation judgement module 141 may further confirm an operation behavior content (for example, a circle selection action or a text highlighting action) of the user to judge whether the designated operation is the screenshot operation or the text selection operation. After obtaining the content to be processed, the content to be processed is transmitted to a remote or local artificial intelligence model for analysis to generate the corresponding result.

The artificial intelligence model is a decision model integrating user behavior/hardware behavior, a large language model (LLM), a recommendation model (for example, a deep learning recommendation model), a generative model, etc. The artificial intelligence model can directly and intuitively perform required artificial intelligence generation in any software interface provided by the electronic apparatus 100, and finally predict several generation task options that the user may intend to execute and reflect the task options on the second display 130 for the user to choose.

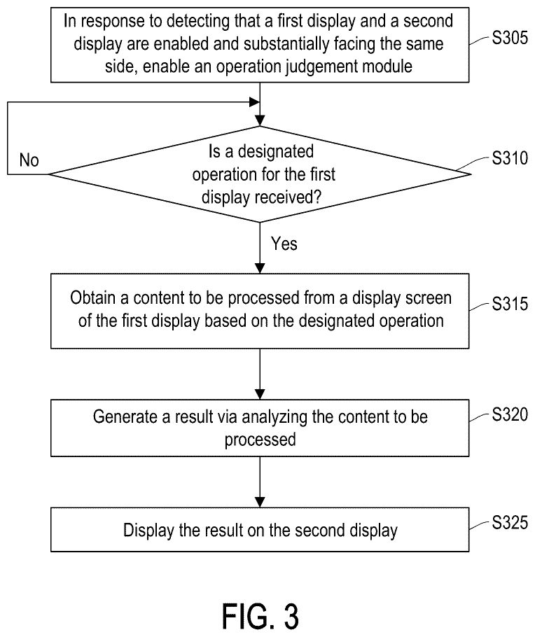

FIG. 4 is a schematic diagram of a screenshot operation according to an embodiment of the disclosure. In the embodiment, in response to the operation judgement module 141 judging that the designated operation is the screenshot operation, a screenshot image is obtained from the display screen of the first display 120 as the content to be processed through the screenshot operation. For example, as shown in FIG. 4, the user may use an operation object such as a mouse, a stylus, or a finger to perform the screenshot operation on the first display 120, thereby dragging a rectangular frame B40 on the display screen of the first display 120 to use a screenshot image 410 selected by the rectangular frame B40 as the content to be processed.

Afterwards, the operation judgement module 141 transmits the screenshot image 410 to the artificial intelligence model for parsing, so that the artificial intelligence model generates a result corresponding to the screenshot image 410. In an embodiment, the artificial intelligence model may be stored in the electronic apparatus 100 or may be set in a cloud server. After the screenshot image 410 is obtained, the screenshot image 410 is transmitted to the artificial intelligence model for processing. For example, image segmentation and feature extraction are performed on the screenshot image 410 through the artificial intelligence model, and image classification is then performed on objects or regions in the screenshot image 410. At the same time, the artificial intelligence model may further perform natural language processing on preset task command descriptions. Finally, an image classification result and a natural language processing result are matched with a knowledge graph, thereby performing image and semantic analysis on the screenshot image 410.

In an embodiment, the artificial intelligence model executing analysis on the screenshot image 410 includes the following steps. (1) In an image processing procedure, pre-processing such as resizing, cropping, and filtering is performed on the screenshot image 410 to improve the effect and the efficiency of subsequent analysis. (2) In an image recognition technique, object features in the screenshot image 410 are extracted, and the object features are classified. (3) In a text recognition procedure, text recognition and extraction are performed. For example, optical character recognition (OCR) is used to recognize and extract text information in the screenshot image 410. A natural language processing (NLP) technique is used to understand the meaning of the text (including the complete description, context, and object information) in the screenshot image 410. (4) In association analysis, contextual understanding and association analysis between image and text are performed. For example, the detected information may be matched with a pre-established knowledge base (the knowledge graph) to enrich the information. Semantic association between various elements in the detection result is analyzed, and contextual understanding is built.

Afterwards, the result obtained via steps (1) to (4) above is displayed on the second display 130. In addition, the task options that the user may intend to provide on the second display 410 may be further inferred according to the text in the screenshot image 410 and the description, the context, and the object information of the screenshot image 410, so as to apply execution functions corresponding to the task options to the first display 120.

In an embodiment, the artificial intelligence model is implemented by adopting an LLM model. The user may use a screenshot tool (for example, “snipping tool”) to drag the rectangular frame B40 on the display screen of the first display 120, thereby obtaining the screenshot image 410. When using the screenshot tool, the display content of the second display 130 may be a preset personalized generated content. After obtaining the screenshot image 410 and before the LLM model is parsed to generate a result, the display content of the second display 130 is the waiting screen (informing the user that the result is currently being generated).

For example, it is assumed that the screenshot image 410 includes a folder, an icon, and a text file, and the LLM model is preset with a task command description, such as “completely describe the situation and the object information shown in the image”, corresponding to the screenshot operation. The LLM model first performs image segmentation and feature extraction on the screenshot image 410 to recognize the folder, the icon, and the text file. Next, the LLM model performs image classification on the folder, the icon, and the text file, thereby confirming that they are respectively the folder, the icon, and the text file. At the same time, the LLM model also performs natural language processing based on the preset task command description “completely describe the situation and the object information shown in the image”, thereby extracting the two keywords “completely describe” and “the situation and the object information”. Finally, the LLM model matches the image classification result (the folder, the icon, and the text file) and the natural language processing result (“completely describe” and “the situation and the object information”) with the knowledge graph or performs association analysis. Accordingly, the LLM model can infer the context and the object information that the screenshot image 410 is intended to describe.

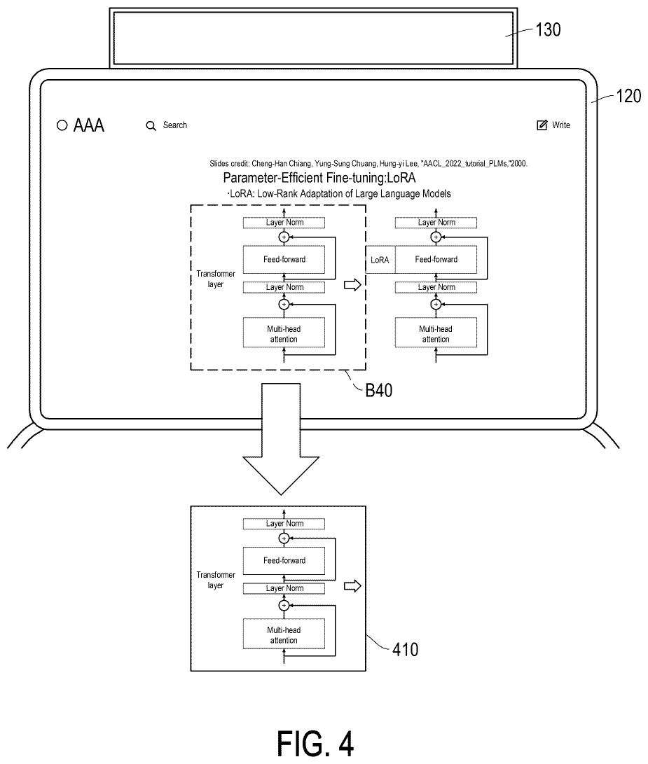

FIG. 5 is a schematic diagram of a text selection operation according to an embodiment of the disclosure. In the embodiment, in response to the operation judgement module 141 judging that the designated operation is the text selection operation, a target text segment is obtained from the display screen of the first display 120 as the content to be processed through the text selection operation. For example, as shown in FIG. 5, the user may use an operation object such as a mouse, a stylus, or a finger to perform the text selection operation (for example, a text highlighting operation) on the first display 120, thereby marking a highlighted block B50 on the display screen of the first display 120 to use a target text segment 510 selected by the highlighted block B50 as the content to be processed.

Afterwards, the operation judgement module 141 transmits the target text segment 510 to the artificial intelligence model for parsing, so that the artificial intelligence model generates a result corresponding to the target text segment 510. For example, the artificial intelligence model executes text segmentation, part-of-speech tagging, syntactic analysis, and semantic analysis on the target text segment 510, and then generates the corresponding result.

In an embodiment, the artificial intelligence model executing analysis on the target text segment 510 includes the following steps. (a) In text segmentation, the text is segmented into words or phrases. (b) In part-of-speech tagging, a part-of-speech tag is assigned to each word or phrase. (c) In syntactic analysis, the structure of a sentence is analyzed. (d) In semantic analysis, the meaning of a sentence is understood. (e) The result is generated according to the processing result.

For example, the artificial intelligence model is implemented by adopting the LLM model. The LLM model is preset with a task command description, such as “please give your opinion on this sentence: [target text segment]”, corresponding to the text selection operation. The LLM model first performs the processing of steps (a) to (d) above on the target text segment 510. At the same time, the LLM model also performs natural language processing on the preset task command description “please give your opinion on this sentence: It's no secret that people with diabetes face a daily challenge that could affect their health on the daily basis.”, thereby extracting keywords. Finally, the LLM model performs association analysis between the text processing result and the natural language processing result. Finally, relevant descriptive text is output.

In an embodiment, after generating the result, the artificial intelligence model may further generate at least one task option based on the result, and display the at least one task option on the second display 130. Each task option corresponds to one execution function. The execution function is, for example, to regenerate, translate, and create a presentation file or search for more information. For example, the artificial intelligence model may generate different results and task options according to different preset task command descriptions.

The task option provides different extended operation choices according to the analysis result. For example, the task option may be an operation for executing a regeneration, an operation for translating the generated result, or an action for searching for more information. Formats of the output result and the task options finally presented on the second display 130 may vary according to the preset task command description, as illustrated below with examples.

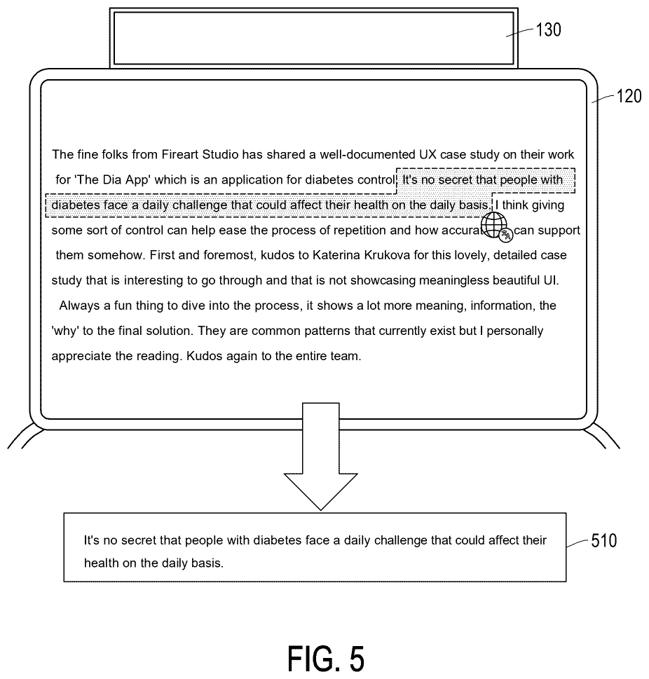

FIG. 6A to FIG. 6C are schematic diagrams of a generation result displayed on a second display based on different task command descriptions according to an embodiment of the disclosure. FIG. 6A shows a format in which only a full text description is generated based on the task command description. As shown in FIG. 6A, the second display 130 displays a full text description 610 and task options 612, 613, and 614. It can be understood that the function executed by the task option 612 is text translation, and the full text description 610 is a part of the translated content displayed based on the task option 612 for the user to preview. FIG. 6B is a schematic diagram of a format in which only search for image by image or search for image by text is generated based on the task command description. As shown in FIG. 6B, the second display 130 displays thumbnails 621, 622, 623, and 624 and task options 625 and 626. It can be understood that the function executed by the task option 625 is to generate an AI image, and the thumbnails 621, 622, 623, and 624 are various AI generated images displayed based on the task option 625 for the user to preview. FIG. 6C is a schematic diagram of a style in which only a full text description and a related link are generated based on the task command description. As shown in FIG. 6C, the second display 130 displays a full text description 631, a related link 632, and task options 633 and 634.

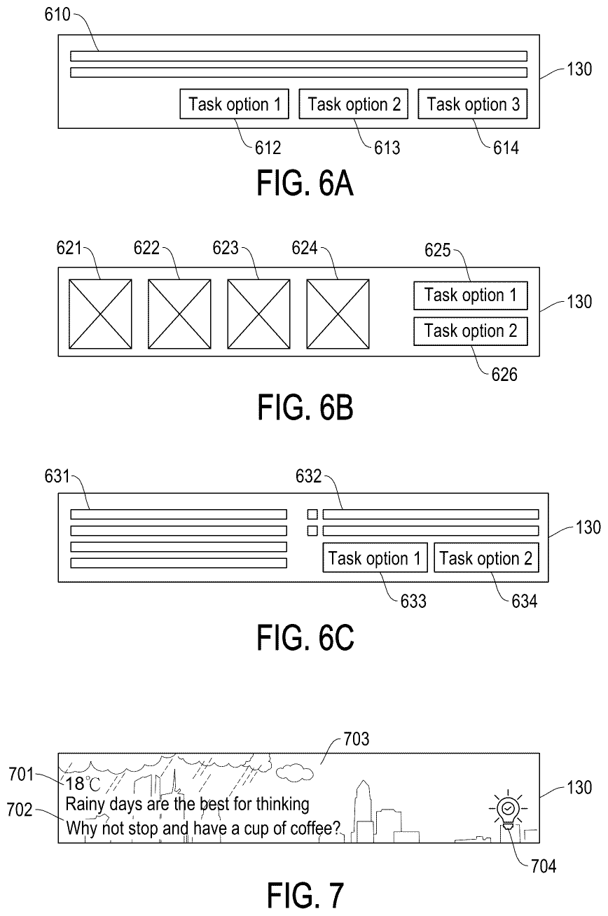

In addition, in the situation where it is judged that the designated operation for the first display 120 is not yet received (no in step S310), the processor 110 may further capture environmental information of the electronic apparatus 100, generate a generated content based on the environmental information through the artificial intelligence model, and display the generated content based on the environmental information on the second display 130, as shown in FIG. 7. FIG. 7 is a schematic diagram of a generated content based on environmental information according to an embodiment of the disclosure. In FIG. 7, the second display 130 displays a temperature message 701, a mood note 702, a background image 703, and a button 704 for updating the display.

In the situation where the electronic apparatus 100 is turned on, a screen showing a standby state after being turned on may be first displayed on the second display 130. For example, the environmental information (for example, system time, location, weather forecast, etc.) of the electronic apparatus 100 is captured, and the environmental information is then transmitted to a cloud or a local artificial intelligence model for analyzing and processing, the generated content based on the environmental information is generated, and the generated content is displayed on the second display 130, as shown in FIG. 7.

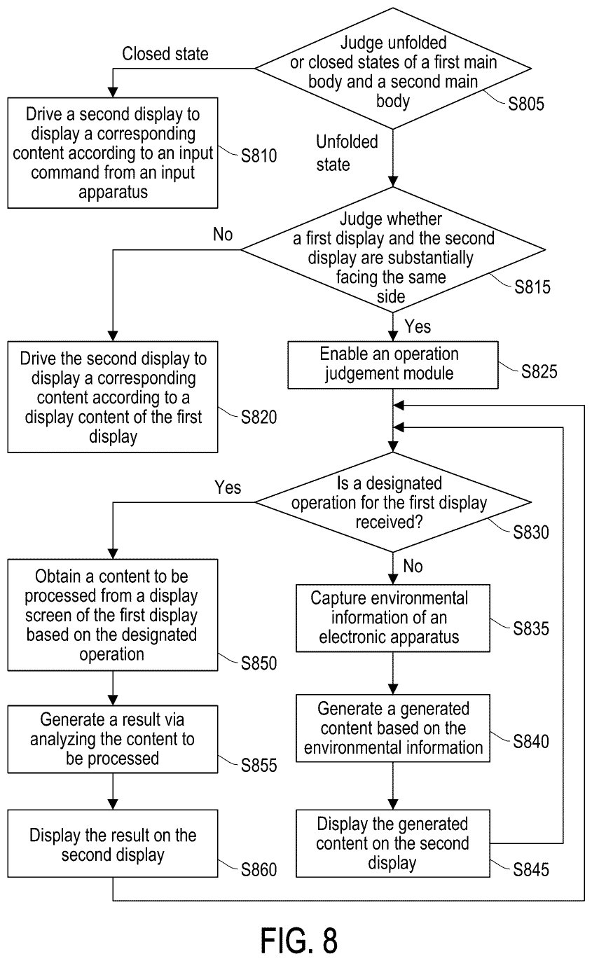

FIG. 8 is a flowchart of a data display method of an electronic apparatus according to an embodiment of the disclosure. In the embodiment, in the situation where the electronic apparatus 100 is turned on, the processor 110 executes the following steps. Please refer to FIG. 8. In step S805, the unfolded or closed states of the first main body 200A and the second main body 200B are judged. That is, it is judged whether the first main body 200A and the second main body 200B are in the closed state (as shown in FIG. 2C and FIG. 2D) or the unfolded state (as shown in FIG. 2A and FIG. 2B).

In response to judging that the first main body 200A and the second main body 200B are in the closed state, in step S810, the second display 130 is driven to display a corresponding content according to an input command from an input apparatus. For example, the input command such as voice, image, and touch operation may be obtained through hardware such as a microphone, a camera, and a touch module of the second display 130 provided by the electronic apparatus 100 to enable an artificial intelligence assistant (an interactive interface provided by a local or remote artificial intelligence model) provided by the electronic apparatus 100, so as to interact with the user through the artificial intelligence assistant, thereby displaying a text or an image content replied by the artificial intelligence model on the second display 130. In addition, the input command may also enable the second display 130 to display the generated content as shown in FIG. 7. Accordingly, the electronic apparatus 100 of the embodiment may also interact with the artificial intelligence assistant through the second display 130 when in the closed state.

In response to judging that the first main body 200A and the second main body 200B are in the unfolded state, in step S815, it is judged whether the first display 120 and the second display 130 are substantially facing the same side. For example, the position of the second display 130 may be judged by detecting the rotation angle of the second display 130 through the behavior sensing module 150 (for example, the motion sensor or the angle sensor).

In the situation where the first display 120 and the second display 130 are not substantially facing the same side (for example, as shown in FIG. 2B), the second display 130 may be used as an auxiliary to the first display 120. In step S820, the second display 130 is driven to display a corresponding content according to the display content of the first display 120. For example, the user may control the second display 130 to present a corresponding content (for example, screen extension, synchronous display, or synchronous translation) associated with the display content of the first display 120 through a software program on the first display 120.

In the situation where the second display 130 is located on a back surface of the first display 120 as shown in FIG. 2B, the first display 120 is for viewing by the main operator, and the second display 130 is for viewing by others, so as to achieve a two-way usage state.

In response to detecting that the first display 120 and the second display 130 are substantially facing the same side, in step S825, the operation judgement module 141 is enabled. Next, in step S830, the processor 110 judges whether the designated operation for the first display 120 is received through the operation judgement module 141. In response to the operation judgement module 141 judging that the designated operation for the first display 120 is received, steps S850 to S860 are executed through the processor 110, and the process then returns to step S830 to continue judging whether the designated operation for the first display 120 is received. Here, reference may be made to steps S305 to S325 of FIG. 3 for detailed descriptions of steps S825, S830, and S850 to S860.

In addition, in the situation where it is judged that the designated operation for the first display 120 is not yet received, steps S835 to S845 are executed, and the process then returns to step S830 to continue judging whether the designated operation for the first display 120 is received. In step S835, the environmental information (for example, system time, location, weather forecast, etc.) of the electronic apparatus 100 is captured. In addition, the environmental information is transmitted to the cloud or the local artificial intelligence model for analyzing and processing.

In step S840, the generated content based on the environmental information is generated through the artificial intelligence model. In step S845, the generated content is displayed on the second display 130. For example, the artificial intelligence model returns an image generated by a deep learning model that matches a current situation, and generates a corresponding positive mood note, as shown in FIG. 8.

In addition, a designated time (for example, 5 minutes) for screen update in the situation where the designated operation for the first display 120 is not yet received may be further set, so that steps S835 to S845 are re-executed after every designated time. In addition, the button for updating the display (for example, the button 704 of FIG. 7) may also be displayed on the second display 130, so that when the button is enabled, steps S835 to S845 are re-executed.

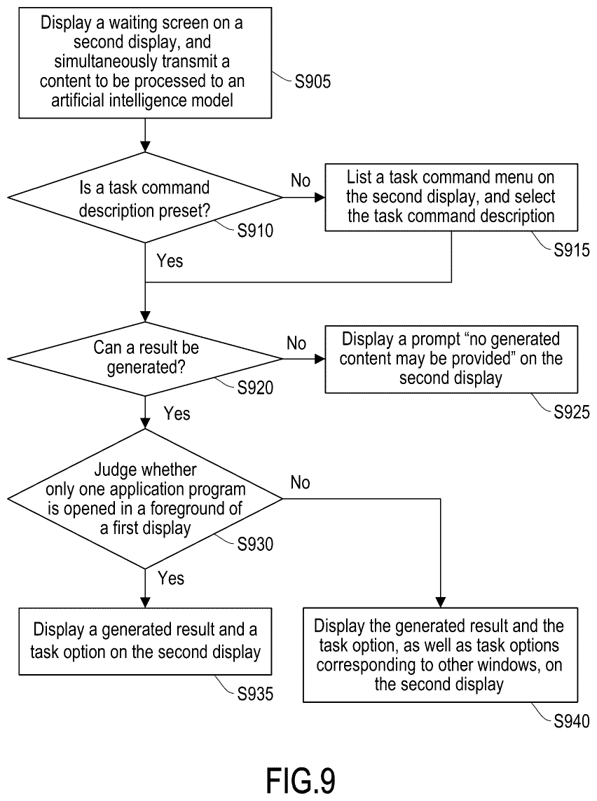

FIG. 9 is a flowchart of generating a result via analyzing a content to be processed according to an embodiment of the disclosure. The embodiment is an application example of step S855. Please refer to FIG. 9. After the content to be processed is obtained, in step S905, the waiting screen is displayed on the second display 130, and the content to be processed is simultaneously transmitted to the artificial intelligence model.

Next, in step S910, the artificial intelligence model judges whether the task command description is preset in internal settings. For example, a task command description corresponding to the screenshot operation and a task command description corresponding to the text selection operation may be set in advance in the artificial intelligence model.

If the task command description is not preset, in step S915, a task command menu is listed on the second display 130, and the task command description is selected. That is, multiple task command descriptions are displayed on the second display 130 for the user to choose, similar to the menu showing the task options 612, 613, and 614 in FIG. 6A, but excluding the full text description 610. A complete display interface as shown in FIG. 6A, FIG. 6B, or FIG. 6C is displayed after the user chooses one of the task options.

After determining the task command description (the preset task command description or the chosen task command description), in step S920, the artificial intelligence model judges whether a result can be generated based on the task command description. If the result cannot be generated, in step S925, a prompt “no generated content may be provided” is displayed on the second display 130. If the result may be generated, in step S930, it is further judged whether only one application program is opened in the foreground of the first display 120. In the situation where it is determined that only one application program is opened in the foreground of the first display 120, in step S935, the generated result and the corresponding task option are displayed on the second display 130. In the situation where it is determined that multiple application programs are opened in the foreground of the first display 120, in step S940, the generated result and the task option, as well as the task options corresponding to other windows, are displayed on the second display 130.

In the situation where multiple windows of multiple application programs are displayed on the first display 120, the task option is associated with the corresponding window based on the designated operation (the screenshot operation or the text selection operation). That is, it is judged which window the designated operation appears, and the result and the task option related to the designated operation are associated with the corresponding window.

For example, before transmitting the content to be processed to the artificial intelligence model, the operation judgement module 141 further judges which application programs are currently opened in the foreground of the first display 120, judges from which window the content to be processed is obtained, and transmits a related message to the artificial intelligence model. When the artificial intelligence model returns the generated result, in which window the current output content (including the generated result and the task option) should be reflected is clearly indicated. Furthermore, when the processor 110 displays the result on the second display 130, and associates the content with the corresponding window.

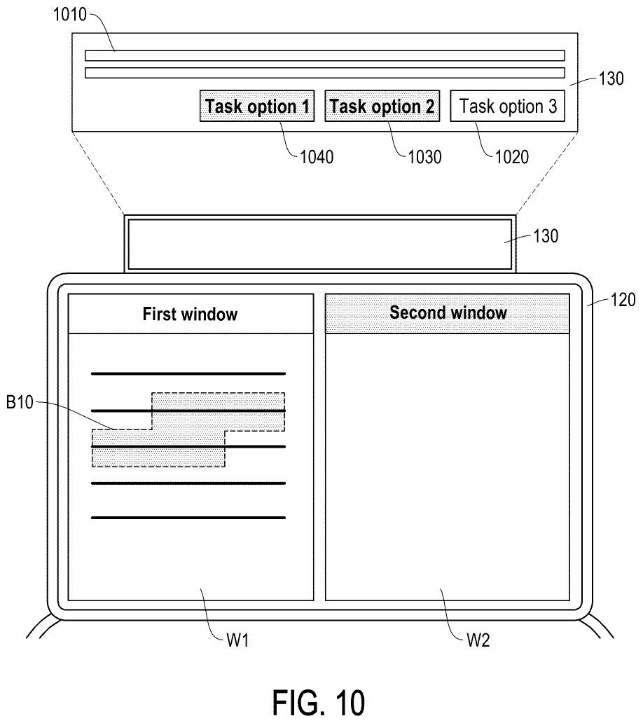

For example, FIG. 10 is a schematic diagram of data display in a multi-window situation according to an embodiment of the disclosure. Please refer to FIG. 10. In the embodiment, the foreground of the first display 120 opens a first window W1 and a second window W2 of two application programs side by side. The user executes the text selection operation in the first window W1 to mark a highlighted block B10. The processor 110 transmits the target text segment selected by the highlighted block B10 and corresponding window information (for example, recognition information such as a serial number and a code for recognizing the first window W1) to the artificial intelligence model, and receives a result 1010 and a task option 1020 generated by the artificial intelligence model to be displayed on the second display 130. In addition, the artificial intelligence model also returns the corresponding window information, so that the operation judgement module 141 may associate the first window W1 with the result 1010 and the task option 1020.

In addition, the window information transmitted by the operation judgement module 141 may further include recognition information of other windows (for example, the second window W2) that are simultaneously displayed in the foreground of the first display 120 side by side. Accordingly, the artificial intelligence model may further generate task options 1030 and 1040 corresponding to the second window W2 to be displayed on the second display 130. For example, functions executed by the task options 1030 and 1040 are respectively “copy and paste the generated result 1010 to the second window W2” and “translate and paste the generated result 1010 to the second window W2”, which are associated with the second window W2, while a function executed by the task option 1020 is “regenerate”, which is not associated with the second window W2.

In an embodiment, association is established by visual presentation. For example, the border color of the first window W1 and the border color of the corresponding task option 1020 are set to the same color. The border colors of the task options 1030 and 1040 generated according to the second window W2 are set to another color.

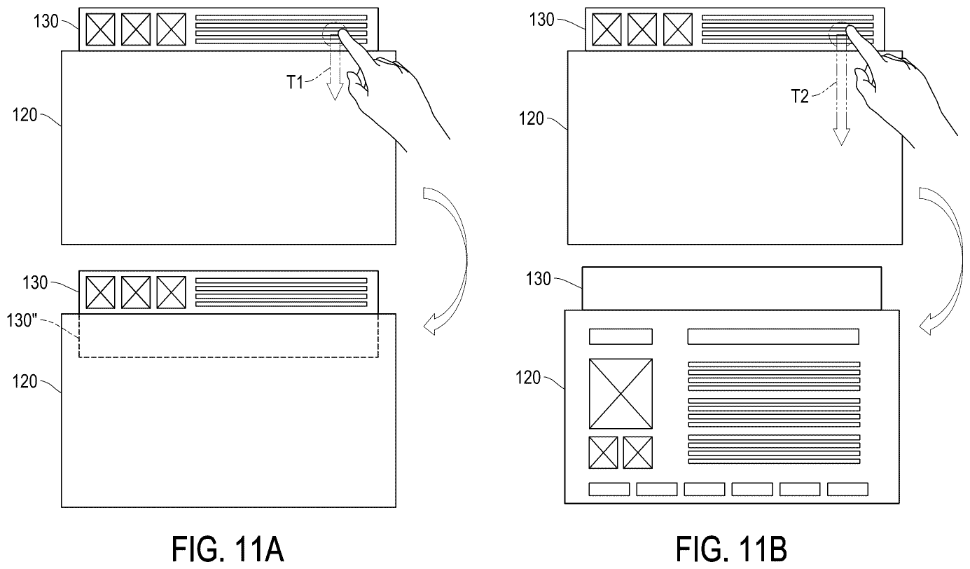

FIG. 11A and FIG. 11B are schematic diagrams of an application example of a second display according to an embodiment of the disclosure. The embodiment is used to illustrate that there are different interactive relationships between the second display 130 and the first display 120. Please refer to FIG. 11A. The user executes a drag operation by touching with a finger, sliding a drag path T1 approximately the height of the second display 130 from top to bottom, and then releases the finger (as shown in the upper part of FIG. 11A). An extended virtual screen 130″ (as shown in the lower part of FIG. 11A) is displayed from the upper edge of the first display 120, and the virtual screen 130″ is used as an extended screen of the second display 130.

Please refer to FIG. 11B. The user executes a drag operation by touching with a finger, sliding a drag path T2 approximately half the height of the first display 120 from top to bottom, and then releases the finger (as shown in the upper part of FIG. 11B). The display content of the second display 130 is directly transferred onto the first display 120 for display (as shown in the lower part of FIG. 11B).

When a distance dragged downward from the second display 130 by the user is equal to the original height of the second display 130, it means that the user only intends to extend the display region of the second display 130 to display more content. However, if the dragging distance exceeds a certain range (such as exceeding half the height of the first display 120), it means that the user intends to fully expand all the content of the second display 130 onto the first display 120.

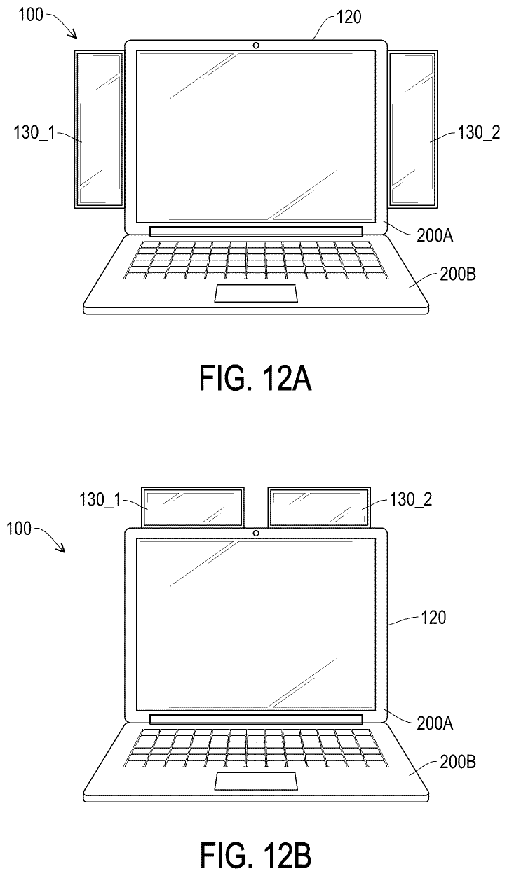

In other embodiments, two second displays may be adopted as secondary displays and the actuating module may be operated in a sliding manner, as shown in FIG. 12A and FIG. 12B. FIG. 12A and FIG. 12B are schematic diagrams of an electronic apparatus according to an embodiment of the disclosure. As shown in FIG. 12A, if second displays 131_1 and 131_2 respectively move from the two sides of the back surface of the first display 120 to face the user through the sliding manner, the behavior sensing module 150 detects the sliding positions of the second displays 130_1 and 131_2 to judge whether the first display 120 and the second displays 130_1 and 131_2 are substantially facing the same side. In addition, as shown in FIG. 12B, the second displays 131_1 and 131_2 may move from above the first display 120 to face the user.

In summary, in the disclosure, the position of the second display relative to the first display is sensed via the behavior sensing module, and after determining that the first display and the second display are substantially facing the same side, the operation judgement module is driven to monitor and confirm the designated operation (for example, the screenshot operation or the text selection operation) for the first display by the user, so as to transmit the content to be processed to the artificial intelligence model for analyzing and generating the result to be presented on the second display. Accordingly, presenting the result of the operation through the second display may not affect the display screen of the first display, thereby improving the working efficiency of the multi-display electronic apparatus. In particular, the disclosure focuses on the interactive operation of artificial intelligence generated content on the multi-display electronic apparatus to enhance the operating experience of the user.

What is claimed is:

1. A data display method of an electronic apparatus, wherein the electronic apparatus comprises a first display and a second display, the data display method comprising executing following steps via a processor:
in response to detecting that the first display and the second display are substantially facing a same side, enabling an operation judgement module; and
in response to judging that a designated operation for the first display is received through the operation judgement module, comprising:
obtaining a content to be processed from a display screen of the first display based on the designated operation;
generating a result via analyzing the content to be processed; and
displaying the result on the second display.

2. The data display method according to claim 1, wherein the step of obtaining the content to be processed from the display screen of the first display based on the designated operation comprises:
in response to the designated operation being a screenshot operation, obtaining a screenshot image from the display screen of the first display as the content to be processed through the screenshot operation;
wherein the step of generating the result via analyzing the content to be processed comprises:
transmitting the screenshot image to an artificial intelligence model for parsing, so that the artificial intelligence model generates the result corresponding to the screenshot image.

3. The data display method according to claim 1, wherein the step of obtaining the content to be processed from the display screen of the first display based on the designated operation comprises:
in response to the designated operation being a text selection operation, obtaining a target text segment from the display screen of the first display as the content to be processed through the text selection operation;
wherein the step of generating the result via analyzing the content to be processed comprises:
transmitting the target text segment to an artificial intelligence model for parsing, so that the artificial intelligence model generates the result corresponding to the target text segment.

4. The data display method according to claim 1, wherein after generating the result, the data display method further comprises:
generating at least one task option based on the result, and displaying the at least one task option on the second display, wherein each of the at least one task option corresponds to an execution function.

5. The data display method according to claim 4, wherein after generating the at least one task option based on the result, the data display method further comprises:
when a plurality of windows of a plurality of application programs are displayed on the first display, establishing an association between the at least one task option and one of the windows based on the designated operation.

6. The data display method according to claim 1, wherein after enabling the operation judgement module, the data display method further comprises:
when judging that the designated operation for the first display is not yet received, capturing environmental information of the electronic apparatus, generating a generated content based on the environmental information through an artificial intelligence model, and displaying the generated content on the second display.

7. The data display method according to claim 1, wherein the step of generating the result via analyzing the content to be processed further comprises:
in response to one of a plurality of task command descriptions displayed on the second display being selected, transmitting the selected one of the task command descriptions and the content to be processed to an artificial intelligence model for parsing, so that the artificial intelligence model generates the result corresponding to the selected one of the task command descriptions.

8. The data display method according to claim 1, wherein the electronic apparatus comprises a first main body and a second main body, wherein the first main body comprises the first display and the second display, the first main body and the second main body are connected through a pivot structure, the first main body and the second main body are in a closed state or an unfolded state via rotation of the pivot structure, and the second display is disposed at a position different from the first display, wherein before enabling the operation judgment module, the data display method further comprises:
in response to judging that the first main body and the second main body are in the unfolded state, detecting the position of the second display through a behavior sensing module to judge whether the first display and the second display are substantially facing the same side.

9. The data display method according to claim 8, wherein before enabling the operation judgment module, the data display method further comprises:
in response to judging that the first main body and the second main body are in the closed state, driving the second display to display a corresponding content according to an input command from an input apparatus via the processor.

10. The data display method according to claim 8, wherein after judging whether the first display and the second display are substantially facing the same side, the data display method further comprises:
in response to the first display and the second display not being substantially facing the same side, driving the second display to display a corresponding content according to a display content of the first display via the processor.

11. An electronic apparatus, comprising:
a first display;
a second display; and
a processor, coupled to the first display and the second display, and configured to:
in response to detecting that the first display and the second display are substantially facing a same side, enable an operation judgement module;
in response to judging that a designated operation for the first display is received through the operation judgement module, comprising:
obtaining a content to be processed from a display screen of the first display based on the designated operation;
generating a result via analyzing the content to be processed; and
displaying the result on the second display.

12. The electronic apparatus according to claim 11, wherein the processor is configured to:
in response to the designated operation being a screenshot operation, obtain a screenshot image from the display screen of the first display as the content to be processed through the screenshot operation; and
transmit the screenshot image to an artificial intelligence model for parsing, so that the artificial intelligence model generates the result corresponding to the screenshot image.

13. The electronic apparatus according to claim 11, wherein the processor is configured to:
in response to the designated operation being a text selection operation, obtain a target text segment from the display screen of the first display as the content to be processed through the text selection operation; and
transmit the target text segment to an artificial intelligence model for parsing, so that the artificial intelligence model generates the result corresponding to the target text segment.

14. The electronic apparatus according to claim 11, wherein the processor is configured to:
generate at least one task option based on the result, and display the at least one task option on the second display, wherein each of the at least one task option corresponds to an execution function.

15. The electronic apparatus according to claim 14, wherein the processor is configured to:
when a plurality of windows of a plurality of application programs are displayed on the first display, establish an association between the at least one task option and one of the windows based on the designated operation.

16. The electronic apparatus according to claim 11, wherein the processor is configured to:
when judging that the designated operation for the first display is not yet received, capture environmental information of the electronic apparatus, generate a generated content based on the environmental information through an artificial intelligence model, and display the generated content on the second display.

17. The electronic apparatus according to claim 11, wherein the processor is configured to:
in response to one of a plurality of task command descriptions displayed on the second display being selected, transmit the selected one of the task command descriptions and the content to be processed to an artificial intelligence model for parsing, so that the artificial intelligence model generates the result corresponding to the selected one of the task command descriptions.

18. The electronic apparatus according to claim 11, further comprising: a first main body and a second main body, wherein the first main body and the second main body are connected through a pivot structure, the first main body comprises the first display and the second display, the first main body and the second main body are in a closed state or an unfolded state via rotation of the pivot structure, and the second display is disposed at a position different from the first display,
the processor is configured to:
in response to judging that the first main body and the second main body are in the unfolded state, detect the position of the second display through a behavior sensing module to judge whether the first display and the second display are substantially facing the same side.

19. The electronic apparatus according to claim 18, wherein the processor is configured to:
in response to judging that the first main body and the second main body are in the closed state, drive the second display to display a corresponding content according to an input command from an input apparatus via the processor.

20. The electronic apparatus according to claim 18, wherein the processor is configured to:
in response to the first display and the second display not being substantially facing the same side, drive the second display to display a corresponding content according to a display content of the first display via the processor.
